(19) United States
(12) Patent Application Publication
(10) Pub. No.: US 2005/0204185 A1
(43) Pub. Date: Sep. 15, 2005

(54) Detecting and identifying data loss

(76) Inventors: Philip J. Tait, Paradise Valley, AZ (US); Chet R. Douglas, Boulder, CO (US); Brian J. Skerry, Gilbert, AZ (US); Richard G. Boyd, Gilbert, AZ (US)

Correspondence Address: INTEL CORPORATION, P.O. BOX 5326, SANTA CLARA, CA, 95056-5326, US

(21) Appl. No.: 10/799,964

(22) Filed: Mar. 11, 2004

(51) Int. Cl. G06F 11/00

(52) U.S. Cl. 714/5

(57) ABSTRACT

In one embodiment, a method is provided. The method of this embodiment provides, in response to a data read request for requested data, allocating an area of memory to the requested data, where the memory area is divided into at least one memory chunk. A seed value is written to one or more of the at least one memory chunk. In response to the completion of at least one write transaction corresponding to the data read request, for each of the one or more memory chunks having a seed value, validating the integrity of the write transaction based, at least in part, on the seed value. Other embodiments are also described and claimed.

### FIELD

Embodiments of this invention relate to detecting and identifying data loss.

### BACKGROUND

End-to-end data integrity is an issue that virtually all computer systems need to address. In some systems, data may be lost as a result of an attempt to write data directly to memory, without intervening controllers or drivers to monitor the write. While a bus driver may be able to detect the data loss, identifying the device from which a data transaction was sent can be a complex task, and may therefore prevent an operating system from accessing complete data. Consequently, systems may respond by deliberately crashing. Where this is not desirable, systems may respond by disabling the detection of such errors. However, ignoring the error may result in data corruption.

For example, in a posted write transaction, a device adapter may write requested data to memory via a DMA (direct memory access) operation via a bus in response to a data request from an operating system. Although the bus driver may be able to detect errors that may occur on the bus, the bus driver may not be able to determine the source of the data, as the data traffic may be voluminous, and data may come from many sources. As a result, the device may not receive any notification as to whether the operation was successful or not. Furthermore, the operating system may not know that the data read request failed, and may attempt to access data that may be incomplete due to one or more failed write transactions.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a system according to one embodiment.

FIG. 2 illustrates a flowchart according to one embodiment.

FIG. 3 illustrates memory seeding and validation according to one embodiment.

### DETAILED DESCRIPTION

Examples described below are for illustrative purposes only, and are in no way intended to limit embodiments of the invention. Thus, where examples may be described in detail, or where a list of examples may be provided, it should be understood that the examples are not to be construed as exhaustive, and do not limit embodiments of the invention to the examples described and/or illustrated.

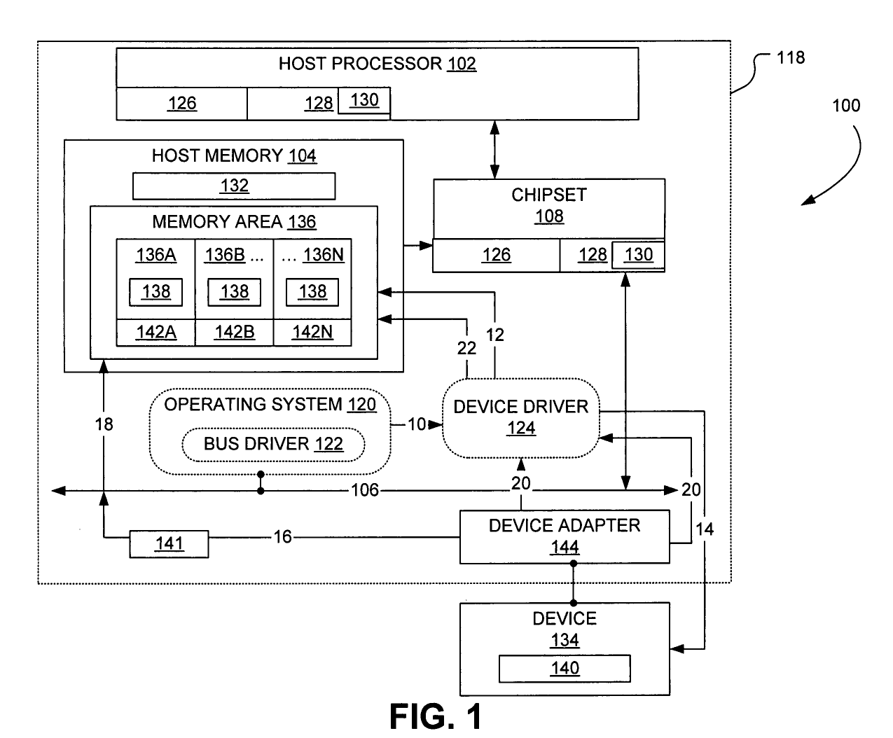

FIG. 1 illustrates a system 100 that may be used in embodiments of the invention. System 100 may comprise host processor 102, chipset 108, bus 106, circuitry 126, and host memory 104, and may communicate with one or more devices 134 (only one shown), such as a peripheral device. Instead of being a peripheral device as illustrated, device 134 may alternatively be integrated on system motherboard 118. System 100 may comprise more than one, and other types of processors, memories, buses, and chipsets; however, these are illustrated for simplicity of discussion. Host processor 102, chipset 108, bus 106, circuitry 126, and host memory 104 may be comprised in a single circuit board, such as, for example, system motherboard 118.

Host processor 102 may comprise, for example, an Intel® Pentium® microprocessor that is commercially available from the Assignee of the subject application. Of course, alternatively, host processor 102 may comprise another type of microprocessor, such as, for example, a microprocessor that is manufactured and/or commercially available from a source other than the Assignee of the subject application, without departing from embodiments of the invention.

Chipset 108 may comprise a host bridge/hub system that may couple host processor 102, and host memory 104 to each other and to bus 106. Alternatively, any of host processor 102, host memory 104, and/or circuitry 126 may be coupled directly to bus 106, rather than via chipset 108. Chipset 108 may also include an I/O bridge/hub system (not shown) that may couple a host bridge/bus system of chipset 108 to bus 106. Chipset 108 may comprise one or more integrated circuit chips, such as those selected from integrated circuit chipsets commercially available from the Assignee of the subject application (e.g., graphics memory and I/O controller hub chipsets), although other one or more integrated circuit chips may also, or alternatively, be used.

Bus 106 may comprise a bus that complies with the PCI-X Specification Rev. 1.0a, Jul. 24, 2000, (hereinafter referred to as a “PCI-X bus”), or a bus that complies with the PCI-E Specification Rev. 1.0a (hereinafter referred to as a “PCI-E bus”), both available from the PCI Special Interest Group, Portland, Oreg., U.S.A. Bus 106 may comprise other types and configurations of bus systems.

Circuitry 126 may comprise one or more circuits to perform one or more operations described herein as being performed by circuitry 126. Circuitry 126 may be hardwired to perform the one or more operations, and/or may execute machine-executable instructions to perform these operations. For example, circuitry 126 may comprise memory 128 that may store machine-executable instructions 130 that may be executed by circuitry 126 to perform these operations. Circuitry 126 may comprise, for example, one or more digital circuits, one or more analog circuits, one or more state machines, programmable circuitry, and/or one or more ASIC's (Application-Specific Integrated Circuits).

Instead of being comprised in host processor 102 or chipset 108, some or all of circuitry 126 may be comprised in other structures, systems, and/or devices that may be, for example, comprised in motherboard 118, and/or communicatively coupled to bus 106, and may exchange data and/or commands with one or more other components in system 100. Many possibilities exist; however, not all possibilities are illustrated.

System 100 may comprise one or more memories to store machine-executable instructions 130, 132 capable of being executed, and/or data capable of being accessed, operated upon, and/or manipulated, by circuitry, such as circuitry 126. For example, these one or more memories may include host memory 104, and/or memory 128. One or more memories 104 and/or 128 may, for example, comprise read only, mass storage, random access computer-accessible memory, and/or one or more other types of machine-accessible memories. The execution of program instructions 130, 132 and/or the accessing, operation upon, and/or manipulation of this data by circuitry 126 may result in, for example, system 100 and/or circuitry 126 carrying out some or all of the operations described herein. As will be discussed, memory area 136 may comprise one or more memory chunks 136A, 136B, . . . , 136N, where at least one of the memory chunks may comprise a seed value 138. System may additionally comprise a device adapter 144. Device adapter 144 may interface between bus 106 and device 134 to manage data transfer. Device adapter 144 may comprise, for example, an HBA (host bus adapter).

System 100 may further comprise programs, such as operating system 120, bus driver 122, and device driver 124, that may perform functions described below by utilizing components of system 100 described above. These programs may be comprised in software, such as machine-executable instructions 130, 132, that may be executed by circuitry, such as circuitry 126, of host processor 102. Of course, these programs may alternatively be comprised in firmware or in hardware.

Embodiments of the present invention may be provided, for example, as a computer program product which may include one or more machine-accessible media having machine-executable instructions that, when executed by one or more machines such as a computer, network of computers, or other electronic devices, may result in the one or more machines carrying out operations in accordance with embodiments of the present invention. A machine-accessible medium may include, but is not limited to, floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable media suitable for storing machine-executable instructions.

Moreover, embodiments of the present invention may also be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

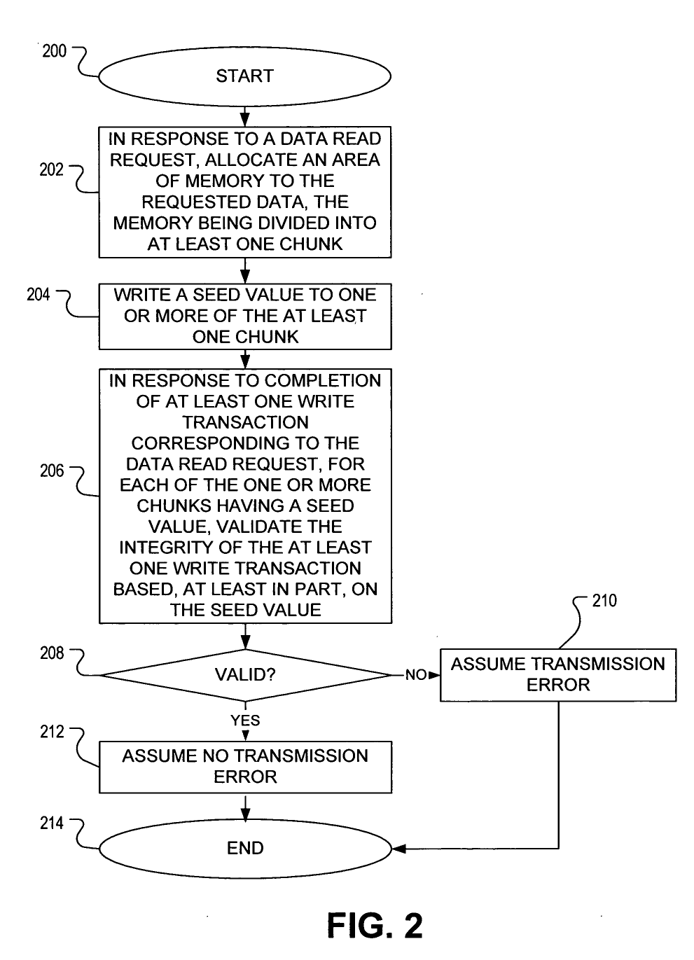

FIG. 2 illustrates a method according to one embodiment of the invention. In this embodiment, circuitry 126 described as performing the operations of this method may be comprised in device driver 124. Other possibilities, however, are possible without departing from embodiments of the invention. For example, rather than device driver 124 writing seed value 138 to memory chunk 136A, 136B, . . . , 136N, operating system 120 may instead perform this operation.

The method begins at block 200 and continues to block 202 where circuitry 126 may, in response to a data read request for data 140 (hereinafter “requested data”, see 10, FIG. 1), allocate an area of memory 136 (hereinafter “memory area”), such as a buffer, to receive returned data 141. In one embodiment, memory area 136 may be divided into at least one memory chunk 136A, 136B, . . . , 136N. A “memory chunk” as used herein refers to a group of contiguous bits of a memory. In one embodiment, the memory chunk size may comprise the smallest group of contiguous bytes that bus 106 may transfer. On a PCI-X bus and a PCI-E bus, for example, the memory chunk size may be less than or equal to 128 bytes.

A data read request may be initiated by an operating system, for example, and may comprise one or more write transactions, where each write transaction may refer to an attempt to write returned data 141 to memory chunk 136A, 136B, . . . , 136N. “Returned data” refers to a copy of at least a portion of requested data that a device adapter may attempt to write, such as to memory chunk 136A, 136B, . . . , 136N. If returned data 141 is successfully written to memory chunk 136A, 136B, . . . , 136N, resulting data 142A, 142B, . . . , 142N may match returned data 141. If returned data 141 is unsuccessfully written to memory area 136, resulting data 142A, 142B, . . . , 142N may not match returned data 141. It should be noted that resulting data 142A, 142B, . . . , 142N that is successfully written to memory chunk 136A, 136B, . . . , 136N may be assumed to be uncorrupted, as error-checking circuitry on bus 106, such as ECC (Error Code Correction), may check for bit-level data corruption of returned data 141. Thus, resulting data 142A, 142B, . . . , 142N may either comprise corresponding portion of requested data 140, or it may comprise a value that includes the seed value 138. A memory chunk 136A, 136B, . . . , 136N to which returned data 141 may be written may be said to correspond to a write transaction, and vice versa.

At block 204, circuitry 126 may write a seed value 138 to at least one of the memory chunks 136A, 136B, . . . , 136N (12, FIG. 1), where the seed value 138 may create a pattern. Seed value 138 may be a predetermined value, or it may be generated by system 100, for example. In one embodiment, a “seed value” refers to a pattern created in specific bits of a memory, such as memory chunk 136A, 136B, . . . , 136N. For example, in this embodiment, a seed value 138 that is written to a memory chunk 136A, 136B, . . . , 136N means that the seed value may only be found in specific, contiguous bits of the memory chunk 136A, 136B, . . . , 136N. In another embodiment, a “seed value” refers to the pattern in any contiguous bits of a memory chunk 136A, 136B, . . . , 136N. For example, in this embodiment, a seed value 138 that is written to a memory chunk 136A, 136B, . . . , 136N means that the seed value 138 may be found in any contiguous bits of the memory chunk 136A, 136B, . . . , 136N. In one embodiment, each memory chunk 136A, 136B, . . . , 136N may comprise a seed value 138. Additionally, each memory chunk 136A, 136B, . . . , 136N may comprise the same seed value 138. Alternatively, one memory chunk 136A, 136B, . . . , 136N may comprise a seed value 138 that is different from another memory chunk 136A, 136B, . . . , 136N.

Seed value 138 may be designed (e.g., predetermined or generated) to avoid common data patterns that may occur in any actual data, such as requested data 140. For example, seed value 138 containing all 0's or all 1's may be avoided. Furthermore, seed value size may be designed so as to minimize performance overhead that may result from writing large seed values 138 to a memory chunk 136A, 136B, . . . , 136N, and/or from testing for large seed values 138 in memory chunks 136A, 136B, . . . , 136N. For example, if a memory chunk size is 128 bytes, then a seed value size of 128 bytes may reduce the chances that the pattern created by the seed value 138 will appear in requested data 140. However, a seed value size of 128 bytes may also incur performance overhead. Therefore, the seed value size may be designed to achieve a compromise between the conflicting goals. In one embodiment, the size of the seed value 138 is based, at least in part, on a specified error rate of a device 134. In this embodiment, seed value size may be designed so that the probability that the seed value 138 will occur in requested data 140 is less than or equal to the specified error rate of device 134.

For example, if the specified error rate of a given device 134 is 10\hat{ }12, the seed value size may be designed such that there is less than a 1 in 10\hat{ }12 probability of the its pattern occurring in the requested data 140. For example, a 41-bit seed value may have a 1 in 2\hat{ }41 probability of occurring, and since 2\hat{ }41 is less than 10\hat{ }12, a 41-bit seed size may be designed. In one embodiment, seed value size may additionally be rounded up to a size that may be processed more efficiently. For example, a 41-bit seed size may be rounded up to a 64-bit seed size in a processor that processes 32-bit values more efficiently.

Circuitry 126 may store information about the data read request in a memory, such as host memory 104. Information may include a transaction I.D. (identification) to be associated with the data read request, and the one or more seed values 138 written to memory chunks 136A, 136B, . . . , 136N allocated to requested data 140 of the data read request. Information may additionally include the length of the memory area 136, and an I/O (input/output) sequence count. In one embodiment, information may also include the bits of memory chunk 136A, 136B, . . . , 136N to which seed value 138 may be written. In this embodiment, a write transaction may be determined to be invalid only if seed value 138 appears in the specified bits of a memory chunk 136A, 136B, . . . , 136N.

Circuitry 126 may provide device 134 with address of memory area 136 to where returned data 141 may be written (14, FIG. 1). Device adapter 144 may write returned data 141 to memory chunk 136A, 136B, . . . , 136N over bus 106 (16, 18, FIG. 1, hereinafater a “write transaction”), such as via a DMA operation. Bus driver 122 may be able to detect errors on bus 106; however, bus driver 122 may not be able to correlate such errors to a device 134.

At block 206, circuitry 126 may, in response to completion of at least one write transaction (16, 18, FIG. 1), validate the integrity of the write transaction based, at least in part, on the seed value 138 (22, FIG. 1). For example, device adapter 144 may notify circuitry 126 (20, FIG. 1) upon completion of at least one write transaction by sending a reply block to circuitry 126, where the reply block may comprise a transaction I.D. Circuitry 126 may use the transaction I.D. to determine one or more seed values 138 to search for in memory chunks 136A, 136B, . . . , 136N.

In one embodiment, circuitry 126 may validate the integrity of a write transaction upon completion of all write transactions associated with a data read request. In another embodiment, circuitry 126 may validate the integrity of a write transaction upon completion of one or more write transactions associated with a data read request.

In one embodiment, the integrity of the write transaction may be validated by determining, for a memory chunk 136A, 136B, . . . , 136N corresponding to the write transaction, if the memory chunk 136A, 136B, . . . 136N comprises the seed value 138. Since a successful write transaction may override the seed value 138 in a memory chunk 136A, 136B, . . . , 136N, a memory chunk 136A, 136B, . . . , 136N that comprises the seed value 138 may mean that the write transaction was invalid, and a memory chunk 136A, 136B, . . . 136N that does not comprise the seed value 138 may mean that the write transaction was valid. In one embodiment, a write transaction may be determined to be invalid if the seed value 138 appears in specified bits of a memory chunk 136A, 136B, . . . , 136N (e.g., bits 0-4). In another embodiment, a write transaction may be determined to be invalid if the seed value 138 appears in any contiguous bits of a memory chunk 136A, 136B, . . . , 136N.

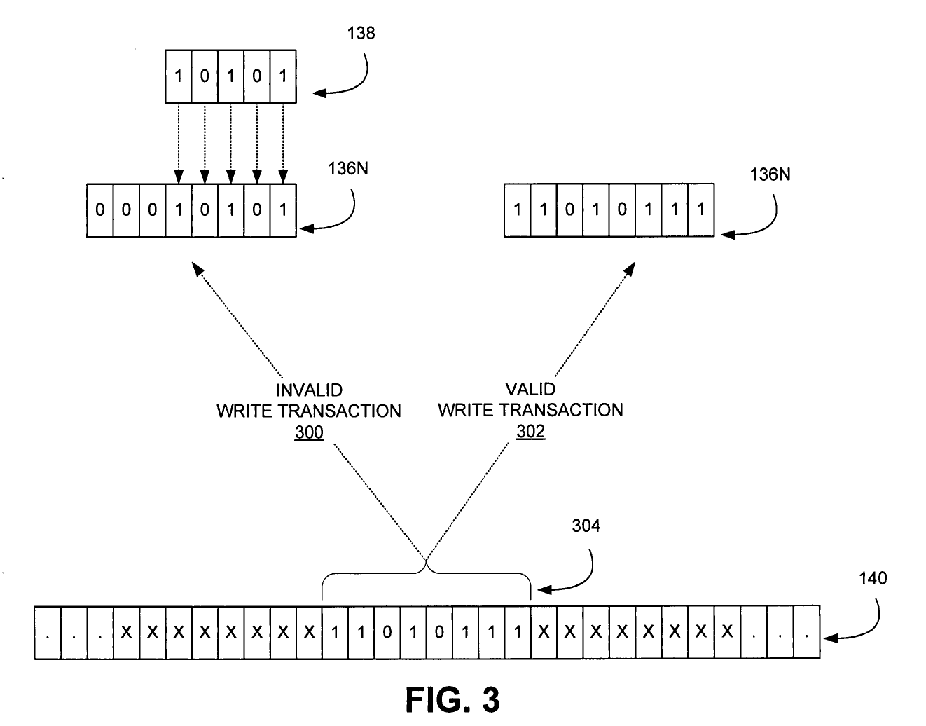

For example, FIG. 3 illustrates seed value 138 “10101”. In this example, seed value 138 may be written to the lower 5 bits of memory chunk 136N. Device adapter 144 (not shown in this figure) may read a portion 304 of requested data 140 from device 134, and attempt to write corresponding returned data 141 (not shown in this figure) to memory chunk 136N. Upon completion of at least one write transaction, if memory chunk 136N comprises seed value 138, then circuitry 126 may determine that the write transaction is invalid 300. If memory chunk 136N does not comprise seed value 138, circuitry 126 may determine that the write transaction is valid 302.

If the integrity of the write transaction is determined to be valid at block 208, circuitry 126 may determine, at block 212, that no transmission error has occurred, and system 100 may, for example, continue with subsequent data read requests. If the integrity of the write transaction is determined to be invalid at block 208, circuitry 126 may determine, at block 210, that a transmission error has occurred. Circuitry 126 may make appropriate system notifications, such as notifying operating system 120. In one embodiment, circuitry 126 may further attempt to rewrite lost portions of requested data 140. In other embodiments, all resulting data 142A, 142B, . . . , 142N corresonding to a given data read request may be discarded, and circuitry 126 may attempt to retry the entire data read request. The method ends at block 214.

Circuitry 126 may falsely determine that a write transaction is invalid if a portion of requested data 140 coincidentally matches seed value 138. In one embodiment, if the same bits of requested data 140 match bits of memory chunk 136A, 136B, . . . , 136N to which seed value 138 is written (i.e., bits 0-4 of requested data 140 match the seed value in bits 0-4 of memory chunk), the write transaction may be falsely determined to be invalid. In another embodiment, if seed value 138 occurs in any portion of requested data 140, the write transaction may be falsely determined to be invalid.

To address a false determination of invalidity of a write transaction, seed value 138 may be modified. This may, for example, reduce repeated errors that may occur from attempting to rewrite the requested data 140 associated with the invalid write transaction. For example, if portion of requested data 140 matches the seed value 138 on a first write transaction, attempts to rewrite the requested data 140 may be unsuccessfully repeated if the seed value 138 remains the same. If the seed value 138 is altered, then on a write transaction of requested data 140 subsequent to the alteration, the requested data 140 should no longer match the seed value 138.

Seed value 138 may be modified by changing its pattern, by changing the occurrence of its pattern in a memory chunk 136A, 136B, . . . , 136N, or both. In one embodiment, the seed value may be modified subsequent to a determination that a write transaction is invalid (i.e., a match has occurred) to ensure the success of the next retry.

### CONCLUSION

Therefore, in one embodiment, a method may comprise, in response to a data read request for requested data, allocating an area of memory to the requested data, the memory area being divided into at least one memory chunk, writing a seed value to one or more of the at least one memory chunk, and in response to the completion of at least one write transaction corresponding to the data read request, for each of the one or more memory chunks having a seed value, validating the integrity of the write transaction based, at least in part, on the seed value.

Embodiments of the invention may enable data loss, such as may occur as a result of a posted-write transaction on a PCI-E or PCI-X bus, for example, to be identified and to be reported to a device from which the data was sent. Writing a seed value to memory chunks enables a device driver, for example, to monitor transactions on the bus, and to correlate such transactions to the sending devices. As a result, data read request completions may be correctly reported to the operating system, which can therefore avoid accessing incomplete data.

In the foregoing specification, the invention has been described with reference to specific embodiments thereof. It will, however, be evident that various modifications and changes may be made to these embodiments without departing therefrom. The specification and drawings are, accordingly, to be regarded in an illustrative rather than a restrictive sense.

1. A method comprising:
in response to a data read request for requested data:
allocating an area of memory to the requested data, the memory area being divided into at least one memory chunk;
writing a seed value to one or more of the at least one memory chunk; and
in response to completion of at least one write transaction corresponding to the data read request, for each of the one or more memory chunks having a seed value, validating the integrity of each of the at least one write transaction based, at least in part, on the seed value.

2. The method of claim 1, wherein said validating the integrity of a given one of the at least one write transaction comprises, for a given memory chunk:
determining if the memory chunk includes the seed value; and
if the memory chunk includes the seed value, determining that a transmission error occurred.

3. The method of claim 2, wherein said determining if the memory chunk includes the seed value comprises determining if the memory chunk includes the seed value at specified bits of the memory chunk.

4. The method of claim 2, additionally comprising modifying the seed value if it is determined that a transmission error occurred.

5. The method of claim 1, wherein the size of the seed value is based on a specified error rate of the device.

6. An apparatus comprising:
circuitry capable of responding to a data read request for requested data by:
allocating an area of memory to the requested data, the memory area being divided into at least one memory chunk;
writing a seed value to one or more of the at least one memory chunk; and
responding to completion of at least one write transaction corresponding to the data read request by, for each of the one or more memory chunks having a seed value, validating the integrity of each of the at least one write transaction based, at least in part, on the seed value.

7. The apparatus of claim 6, wherein said circuitry capable of validating the integrity of a given one of the at least one write transaction is capable of, for a given memory chunk:
determining if the memory chunk includes the seed value; and
if the memory chunk includes the seed value, determining that a transmission error occurred.

8. The apparatus of claim 7, wherein said circuitry capable of determining if the memory chunk includes the seed value is capable of determining if the memory chunk includes the seed value at specified bits of the memory chunk.

9. The apparatus of claim 7, wherein said circuitry is additionally capable of modifying the seed value if it is determined that a transmission error occurred.

10. The apparatus of claim 6, wherein the size of the seed value is based on a specified error rate of the device.

11. A system comprising:
a PCI-E (Peripheral Component Interconnect-Express) bus;
a buffer communicatively coupled to the PCI-E bus, the buffer being divided into at least one memory chunk; and
circuitry capable of responding to a data read request for requested data by:
allocating the buffer to the requested data, the buffer being divided into at least one memory chunk;
writing a seed value to one or more of the at least one memory chunk; and
responding to completion of at least one write transaction corresponding to the data read request by, for each of the one or more memory chunks having a seed value, validating the integrity of each of the at least one write transaction based, at least in part, on the seed value.

12. The system of claim 11, wherein said circuitry capable of validating the integrity of a given one of the at least one write transaction is capable of, for a given memory chunk;
determining if the memory chunk includes the seed value; and
if the memory chunk includes the seed value, determining that a transmission error occurred.

13. The system of claim 12, wherein said circuitry capable of determining if the memory chunk includes the seed value is capable of determining if the memory chunk includes the seed value at specified bits of the memory chunk.

14. The system of claim 12, wherein said circuitry is additionally capable of modifying the seed value if it is determined that a transmission error occurred.

15. The system of claim 11, wherein the size of the seed value is based on a specified error rate of the device.

16. An article comprising a machine-readable medium having machine-accessible instructions, the instructions when executed by a machine, result in the following:
responding to a data read request for requested data by:
allocating an area of memory to the requested data, the memory area being divided into at least one memory chunk;
writing a seed value to one or more of the at least one memory chunk; and
responding to completion of at least one write transaction corresponding to the data read request by, for each of the one or more memory chunks having a seed value, validating the integrity of each of the at least one write transaction based, at least in part, on the seed value.

17. The article of claim 16, wherein said instructions that result in validating the integrity of a given one of the at least one write transaction comprise instructions that result in, for a given memory chunk:
determining if the memory chunk includes the seed value; and
if the memory chunk includes the seed value, determining that a transmission error occurred.

18. The article of claim 17, wherein the instructions that result in determining if the memory chunk includes the seed value comprise instructions that result in determining if the memory chunk includes the seed value at specified bits of the memory chunk.

19. The article of claim 17, additionally comprising instructions that result in modifying the seed value if it is determined that a transmission error occurred.

20. The article of claim 16, wherein the size of the seed value is based on a specified error rate of the device.
